(19) United States
(12) Patent Application Publication
(10) Pub. No.: US 2018/0207643 A1
(43) Pub. Date: Jul. 26, 2018

(54) CRUSHING MILL

(71) Applicant: COLOMBO GIOVANNI S.R.L., Daverio (IT)

(72) Inventor: Claudio COLOMBO, Varese (IT)

(21) Appl. No.: 15/746,485

(22) PCT Filed: Jul. 22, 2016
(86) PCT No.: PCT/IB2016/054395

§ 371 Date: Jan. 22, 2018

(30) Foreign Application Priority Data
Jul. 23, 2015 (IT) 102015000037573

(51) Int. Cl. B02C 13/286; B02C 23/04

(52) U.S. Cl. CPC B02C 13/286; B02C 2013/28618; B02C 2201/06; B02C 23/04

(57) ABSTRACT

A crushing mill includes a crushing chamber and a feed unit to feed the waste to be crushed positioned upstream of the crushing chamber. Upstream of the feed unit a first aperture is positioned for the inlet of the waste to be treated in the feed unit and, downstream of the feed unit, a second transfer aperture is positioned to transfer the waste to be treated toward the crushing chamber. The feed unit includes a member rotatable around a determinate axis and provided with at least a pair of cylindrical sectors angularly offset with respect to the axis, provided with corresponding inlet and discharge apertures of the waste to be crushed and configured so that, in any loading and/or crushing step of the waste to be crushed in the crushing mill, they prevent the first and second apertures from coming into communication with each other.

### FIELD OF THE INVENTION

The present invention concerns a crushing mill, usable in particular to crush objects with a relatively limited size, for example objects up to 30 cm in bulk, such as WEEE, that is, waste electrical or electronic equipment.

In particular, the present invention concerns a unit for feeding the waste into the crushing mill.

### BACKGROUND OF THE INVENTION

Known crushing or grinding mills comprise a crushing or grinding chamber with a crushing unit provided for example with a plurality of crushing hammers moved by a corresponding motor or other drive member. The crushing chamber comprises an aperture for loading the waste to be crushed and is generally disposed downstream of a feed device suitable to introduce the scrap to be crushed into the chamber. The feed device can be associated with means for conveying the scrap, like a slide, a hopper or suchlike.

One disadvantage of known crushing mills, and in particular of mills for crushing objects of limited size, is connected to their limited safety, since the waste being crushed can accidentally come out through the loading aperture of the crushing chamber.

During the crushing process, the crushing mill rotates at relatively high rotation speeds, up to 400 rpm, therefore any waste fragment or part being worked that accidentally comes out of the crushing mill is a serious danger for the operators responsible for the functioning of the crushing mill.

Another disadvantage of known crushing mills is that they have difficulty in crushing the waste in a substantially uninterrupted sequence.

It is therefore desirable that crushing mills should work in complete safety and also that they should guarantee a continuous loading and crushing of the waste.

One purpose of the present invention is to obtain a crushing mill that overcomes the shortcomings of known crushing mills cited above and that is provided with a feed unit that prevents the waste crushed or being crushed from coming out from the crushing chamber during any working step of the crushing mill, whether it is a step of loading the waste and/or a working or crushing step.

Another purpose of the present invention is to obtain a crushing mill which allows to introduce, quickly, efficiently and directly, a certain quantity of waste inside the crushing chamber of the mill, making the process of feeding and crushing the waste safe and substantially continuous.

Another purpose of the present invention is to obtain a crushing mill which has great compactness and efficiency.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purposes, a crushing mill comprises a crushing chamber and a feed unit to feed the waste to be crushed positioned upstream of the crushing chamber; upstream of the feed unit a first aperture is positioned for the inlet of the waste to be treated in the feed unit, and downstream of the feed unit a second transfer aperture is positioned to transfer the waste to be treated toward the crushing chamber.

According to a characteristic aspect of the invention, the feed unit comprises a member rotatable around a determinate axis and provided with at least a pair of cylindrical sectors angularly offset with respect to the axis, provided with corresponding inlet and discharge apertures of the waste to be crushed and configured so that, in any loading and/or crushing step of the waste to be crushed in the crushing mill, they prevent the first and second apertures from coming into communication with each other.

Advantageously, using the present crushing mill, it is possible to proceed with an efficient, safe and substantially continuous treatment of crushing and loading the waste, preventing the waste spilling in an unwanted manner from the crushing chamber. The inlet apertures of the crushing unit and of the crushing chamber are indeed advantageously never in communication with each other, whatever the work and/or loading step of the crushing mill. Moreover, by directly directly introducing the waste into the cylindrical sectors it is possible to obtain an extremely compact crushing mill.

According to another aspect of the invention, the feed unit comprises a thrust diaphragm to thrust the waste toward the crushing chamber.

Preferably, the thrust diaphragm forms part of both the cylindrical sectors provided in the member of the feed unit.

The diaphragm that thrusts the waste toward the crushing chamber preferably passes through the axis of rotation of the member of the feed unit.

Preferably, the cylindrical sectors are made in diametrically opposite positions with respect to the axis of rotation of the member of the feed unit.

According to other characteristics of the invention the cylindrical sectors have the same amplitude, preferably about 90°.

The present invention also concerns a method to crush waste which provides to introduce the waste into a feed unit through a first inlet aperture, to feed the waste, with the feed unit and through a second aperture, into a crushing chamber and to crush the waste in the crushing chamber.

According to a characteristic of the present method, the feed unit comprises a member rotatable around a determinate axis and provided with at least a pair of cylindrical sectors angularly offset with respect to the axis and provided with corresponding inlet and discharge apertures of the waste to be treated; the waste is introduced through the first inlet aperture and one of the apertures of the cylindrical sectors in one of the cylindrical sectors and is subsequently discharged from the cylindrical sectors, through the second aperture, into the crushing chamber, making the rotatable member rotate; during the rotation of the rotatable member, the cylindrical sectors are positioned so as to always prevent direct communication between the first and second apertures.

According to another aspect of the invention, while one cylindrical sector closes the inlet aperture of the waste to the crushing chamber, the other cylindrical sector at least partly closes the access aperture of the waste to the feed unit.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a view in lateral elevation and in section of a crushing mill according to the present invention;

FIG. 2a is a view in lateral elevation and in section of a first executive form of a feed unit of the waste of the crushing mill in a work and loading step of the waste;

FIG. 2b is a view in lateral elevation and in section of the feed unit of the waste in FIG. 2a in a transfer step of the waste toward the crushing chamber;

FIG. 2c is a view in lateral elevation and in section of the feed unit of the waste of the preceding drawings in a discharge step of the waste toward the crushing chamber and introduction of a new load of waste;

FIG. 2d is a view in lateral elevation and in section of the feed unit of the preceding drawings in a thrust step of the waste toward the crushing chamber;

FIG. 2e is a view in lateral elevation and in section of the feed unit of the waste of the preceding drawings in a discharge step of the waste into the crushing chamber;

FIG. 3 is a view in lateral elevation of an executive variant of the feed unit of the waste of the present crushing mill.

To facilitate comprehension, the same reference numbers have been used, where possible, to identify identical common elements in the drawings.

### DETAILED DESCRIPTION OF SOME EMBODIMENTS

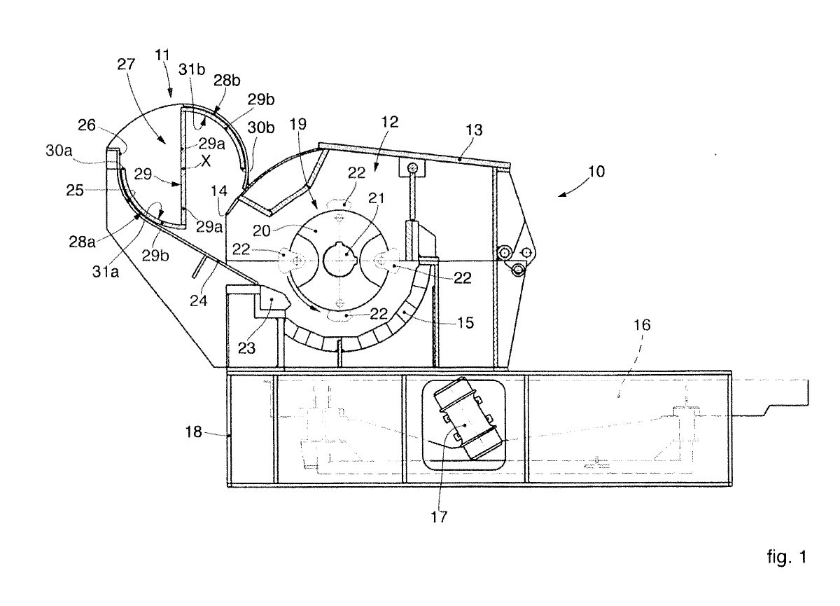

With reference to the enclosed drawings and in particular to FIG. 1, a crushing mill according to the present invention is indicated by the reference number 10. The crushing mill 10 comprises a feed unit 11 to feed the waste, for example WEEE, toward a crushing chamber 12. The crushing chamber 12 is made inside an upper frame 13 of the crushing mill 10 and comprises an inlet aperture 14 of the waste to be treated and a bottom 15 that can comprise means for sieving the crushed waste. The crushed or ground waste passes toward a vibrating transporter 16 provided with suitable drive means 17 and housed in a base 18 of the crushing mill 10. The vibrating transporter 16 has the function of discharging the crushed waste from the crushing mill 10.

Inside the crushing chamber 12 a crushing device 19 is housed that comprises a rotor 20 provided centrally with a substantially horizontal rotation shaft 21. The rotor 20 is connected to suitable drive means not shown in the drawings, for example an electric motor with adjustable speed or suchlike. The rotor 20 has a series of crushing hammers 22, for example four, located on the periphery and preferably equidistant from each other. Each of the hammers 22 is able to interact, during the rotation of the rotor 20, with an end part 23 of a loading slide 24, in order to crush or grind the waste. The end part 23 and the hammers 22 of the rotor can be interchangeable, in order to be able to possibly later replace them for example after normal wear and tear.

The feed unit 11 of the waste to be crushed comprises a cylindrically-shaped fixed seating 25 located upstream of the slide 24 and communicating with the waste inlet aperture 14 into the crushing chamber 12. The fixed seating 25 also comprises an inlet aperture 26 of the waste to be crushed inside the feed unit 11.

A cylindrically-shaped member 27 is housed inside the fixed seating 25 and is able to rotate around a substantially horizontal axis X, by means of suitable drive means (not shown), for example an electric motor with adjustable speed. The member 27 comprises two cylindrical sectors 28a and 28b angularly offset with respect to the axis X and in particular made in positions diametrically opposite with respect to the axis X. The disposition of the cylindrical sectors 28a and 28b in diametrically opposite positions allows to equidistance them from each other and obtain a uniform functioning of the feed unit 11. The cylindrical sectors 28a and 28b preferably have equal amplitude, for example an amplitude of 90°, and each of them is closed on one side by a central diaphragm 29 that passes through the axis X and, on the other side, have respectively an aperture 30a and 30b. The member 27 therefore is substantially S-shaped.

In particular, each cylindrical sector 28a and 28b is defined by a first wall 29a of the diaphragm 29 with a development substantially radial with respect to the axis X, and a second wall 29b attached to an end edge of the first wall 29a, and having a development substantially circumferential with respect to the axis X. The first wall 29a and the second wall 29b of the first cylindrical sector 28a and the second cylindrical sector 28b together define a compartment 31a and respectively 31b, open toward the outside through the apertures 30a and 30b.

The first walls 29a together define the central diaphragm 29.

Compartments 31a and 31b are configured to accommodate during use, and when the apertures 30a and 30b are facing substantially upward, the waste that is to be subsequently introduced into the crushing chamber 12. By rotating the rotary member 27, the waste loaded in compartment 31a or 31b is discharged through aperture 14, disposing apertures 30a and 30b facing downward. The second walls 29b, during the rotation of the rotary member 27, are disposed on each occasion to completely close the apertures 14 or 26.

The amplitude of each of the second walls 29b of the cylindrical sectors 28a and 28b is greater than the amplitude of the apertures 26 and 14 through which the waste enters into the feed unit 11 and into the crushing chamber 12, so that, during functioning, together with the central diaphragm 29, possible spillages of crushed waste from the chamber 12 are prevented, and so that the inlet aperture 26 of the waste to be processed to the feed unit 11 is possibly closed. The cylindrical sectors 28a and 28b substantially represent kinds of temporary compartments for the waste that has to be sent to the crushing chamber 12.

The cylindrical sectors 28a, 28b are therefore configured so that, whatever the position assumed by the rotary member 27, the apertures 26 and 14 never communicate with each other, thus preventing the possibility of spillage of possible fragments of waste during crushing.

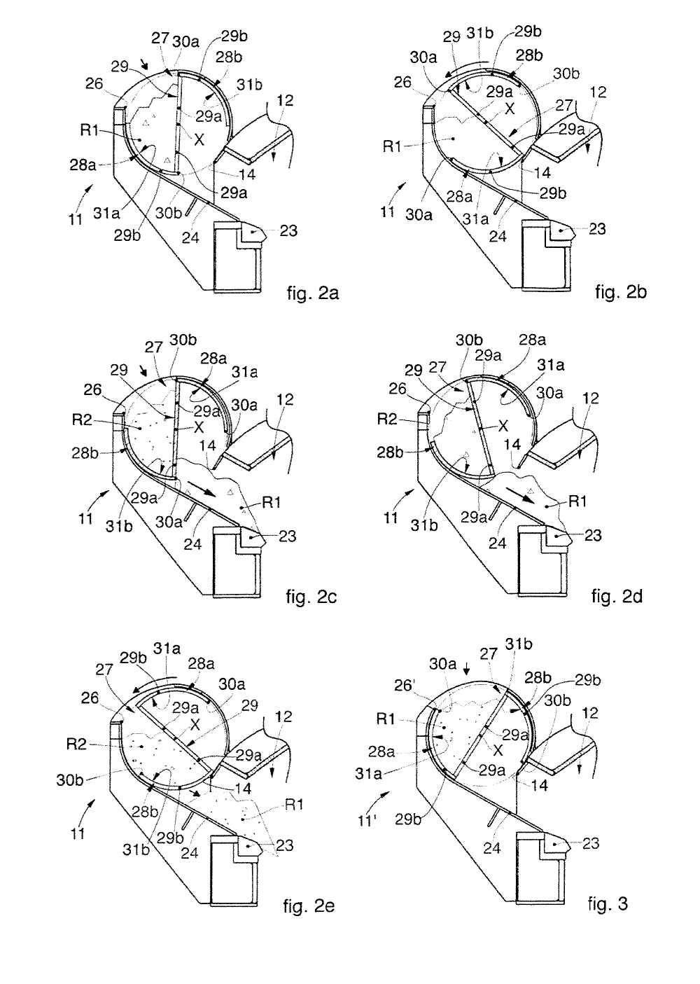

FIG. 2a shows a loading step of a first quantity of waste R1 inside the compartment 31a defined by sector 28a of the rotary member 27, through the corresponding aperture 30a. In this embodiment of the feed unit 11, the aperture 26 is also suitable to receive waste in a slightly inclined position, whereas, as can be seen, in this step the diaphragm 29 of the rotary member 27 is in a practically vertical position.

In the position in FIG. 2a, the crushing mill 10 performs not only the operation of loading the quantity of waste R1 but also an operation of crushing the waste previously loaded. Therefore, in substance, in FIG. 2a the crushing mill 10 is both loading and crushing.

Following an anti-clockwise rotation of the rotary member 27 around axis X (see FIG. 2b), the cylindrical sector 28b moves to partly close the introduction aperture 26, while the waste R1 begins to descend along the slide 24. In this step the circumferential wall 29b of the cylindrical sector 28a closes the entrance aperture 14 to the crushing chamber 12.

The rotary member 27 continues to rotate around axis X (see FIG. 2c) so that the diaphragm 29 returns to a practically vertical position, hence with a rotation of substantially 180°. The waste R1 descends along the slide 24 to reach the crushing chamber 12 where it will be crushed by the crushing device 19 in FIG. 1. Advantageously, during the rotation of the rotary member 27, the diaphragm 29 starts to thrust the waste R1 along the slide 24, therefore contributing to its correct transfer to the crushing chamber 12. While the first load of waste R1 descends along the slide 24 toward the crushing chamber 12, the aperture 30b moves into correspondence with the aperture 26 to load the waste into the rotary member 27 of the feed unit 11, so that a new load of waste R2 can be introduced inside cylindrical sector 28b through aperture 30b.

Load R1 advantageously continues to be thrust by the lower edge of the diaphragm 29 toward the crushing chamber 12 (compare FIGS. 2c and 2d), sliding toward the crushing chamber 12 until the lower edge of the diaphragm 29 returns along the feed unit 11 (FIG. 2e).

At this point the load R1 of waste will start to be crushed by the crushing device 19 in FIG. 1, by the action of the hammers 22.

During each crushing and/or loading step, advantageously and as can be seen from the drawings described here, the rotary member 27 of the feed unit 11 is in a position such that, as we said, the apertures 24 and 26 never communicate with each other. In this way, any possible spillage of waste crushed by the crushing chamber 12 to the feed unit 11 and toward the outside is prevented.

In each of the steps, it is possible to temporarily stop the rotary member 27 so as to allow the complete crushing of the waste R1. When the crushing process is finished, the new load of waste R2 to be crushed, contained in the cylindrical sector 28b, is immediately ready to be transferred to the crushing chamber 12.

When the aperture 14 for discharging the waste to the crushing chamber 12 is closed, the aperture 26 for loading the waste into the feed unit 11 is at least partly closed by the other cylindrical sector 28a, so as to prevent non-programmed loads of waste and so as to follow a suitably programmed continuous loading and crushing cycle.

As can be understood by examining the functioning sequence shown of the feed unit 11 of the crushing mill 10 according to the present invention, the cycles of crushing and loading the waste can be programmed and timed in a suitable way so as to have a continuous, efficient and safe functioning of the crushing mill 10. Moreover, advantageously, the sectors 28a and 28b located in diametrically opposite positions guarantee an effective uniformity of the process of loading and crushing the waste.

The waste, crushed at the end of the process, pass to the vibrating transporter 16 to be discharged from the crushing mill 10.

In a variant of the invention (see FIG. 3), the feed unit 11′ comprises an aperture 26′ situated in a substantially horizontal or slightly inclined position, hence particularly suitable for loading waste R1 from above. The rotary member 27 remains exactly the same as the one shown in the previous drawings, the only difference being the initial position. In fact, as can be seen, in this case the diaphragm 29 dividing the two cylindrical sectors 28a and 28b in the loading step of the waste R1 is in a slightly inclined position and not in a practically vertical position, as in FIGS. 2a-2d. In the position in FIG. 3, the crushing mill 10 is in a step of loading a certain quantity of waste R1 and a crushing step of a load of waste previously loaded.

It is clear that modifications and/or additions of parts may be made to the crushing mill as described heretofore, without departing from the field and scope of the present invention.

It is also clear that, although the present invention has been described with reference to some specific examples, a person of skill in the art shall certainly be able to achieve many other equivalent forms of crushing mill, having the characteristics as set forth in the claims and hence all coming within the field of protection defined thereby.

1. A crushing mill, comprising a crushing chamber and a feed unit to feed the waste to be crushed positioned upstream of said crushing chamber, upstream of the feed unit there being positioned a first aperture for the inlet of the waste to be treated in the feed unit and, downstream of the feed unit, there being positioned a second transfer aperture to transfer the waste to be treated toward the crushing chamber, wherein said feed unit comprises a member rotatable around a determinate axis and provided with at least a pair of cylindrical sectors angularly offset with respect to said axis, provided with corresponding inlet and discharge apertures of the waste to be crushed and configured so that, in any loading and/or crushing step of the waste to be crushed in the crushing mill, the inlet and discharge apertures prevent said first and second apertures from coming into communication with each other.

2. The mill as in claim 1, wherein the feed unit comprises a thrust diaphragm to thrust the waste toward the crushing chamber.

3. The mill as in claim 2, wherein said thrust diaphragm forms part of both the cylindrical sectors provided in the member of the feed unit.

4. The mill as in claim 2, wherein said thrust diaphragm of the waste toward the crushing chamber passes through the axis of rotation of said member of the feed unit.

5. The mill as in claim 1, wherein said cylindrical sectors are made in positions diametrically opposite with respect to the axis of rotation of the member of the feed unit.

6. The mill as in claim 1, wherein said cylindrical sectors have an equal amplitude.

7. The mill as in claim 1, wherein said cylindrical sectors both have an amplitude of about 90°.

8. A method to crush waste comprising introducing, through a first inlet aperture, said waste into a feed unit, feeding said waste, with said feed unit and through a second aperture, into a crushing chamber and crushing said waste in said crushing chamber, wherein said feed unit comprises a member rotatable around a determinate axis and provided with at least a pair of cylindrical sectors angularly offset with respect to said axis and provided with corresponding inlet and discharge apertures of the waste to be treated, and further comprising introducing said waste through said first inlet aperture and one of said apertures in one of said cylindrical sectors and subsequently discharging from said cylindrical sectors, through said second aperture, into said crushing chamber, making said rotatable member rotate, and during the rotation of said rotatable member said cylindrical sectors are positioned so as to always prevent the direct communication between said first and second apertures.

9. The method as in claim 8, wherein while one cylindrical sector closes the inlet aperture of the waste to the crushing chamber, the other cylindrical sector at least partly closes the access aperture of the waste to the feed unit.
